(19) United States
(12) Patent Application Publication
(10) Pub. No.: US 2020/0287726 A1
(43) Pub. Date: Sep. 10, 2020

(54) REMOTE DEVICE CONTROL

(71) Applicant: Arm Limited, Cambridge (GB)

(72) Inventors: Donatien Marie Pierre-Yves Melchior GARNIER, Cambridge, Cambridgeshire (GB); Jerome Yi-Zhe JOAUG, Cambridge, Cambridgeshire (GB)

(21) Appl. No.: 16/648,078

(22) PCT Filed: Nov. 23, 2018
(86) PCT No.: PCT/GB2018/053397

§ 371 Date: Mar. 17, 2020

(30) Foreign Application Priority Data
Nov. 23, 2017 (GB) 1719462.2

(51) Int. Cl. H04L 9/32; H04L 29/06; G06F 8/65; G06F 1/12; H04L 12/66; H04L 29/08

(52) U.S. Cl. CPC H04L 9/3263; H04L 63/08; H04L 63/1416; G16Y 10/75; G06F 1/12; H04L 12/66; H04L 67/12; G06F 8/65

(57) ABSTRACT

Disclosed is a server arrangement for control of remote devices, such as Internet of Things devices. The server arrangement comprises a network interface for connection to a gateway device, a data store, and processing means. The processing means are configured to establish through the network interface a network connection to the gateway device, transfer security credentials over the network connection to the gateway device, to enable the gateway device to obtain control of one or more Internet of Things devices, establish an agency relationship with the gateway device to authorise the gateway device to perform control of Internet of Things devices on behalf of the server arrangement, creating a distributed management architecture, assign tasks to be performed the gateway device on behalf of the server arrangement, receive from the gateway device event data relating to Internet of Things devices, and store the event data in the data store.

### TECHNICAL FIELD

The present disclosure relates generally to remote device control; and more specifically, to devices and methods for control of remote devices such as Internet of Things (IoT) devices.

### BACKGROUND

With the rapid development of data communication technology, human life is getting faster and easier. Furthermore, with fusion of the data communication technology and Internet technology, the accessibility of objects has increased. The Internet of Things (IoT) is a network of physical objects that is capable of making physical objects readable, recognizable, locatable, addressable, and controllable. Typically, the physical objects may be computing devices, mechanical and digital machines, items, animals or people.

However, conventional Internet of Things networks include certain drawbacks. For example, a conventional Internet of Things network includes a centralized server that is connected to an electronic device that is attached to a physical object. The electronic device attached to the physical object is responsible for collecting data related to the physical object and transferring the data to the centralized server. Additionally, the electronic device that is attached to the physical object is a low power sensory device and is often located in regions where high speed data connectivity is difficult to establish. Therefore, such network architecture is susceptible to data loss and lack of connectivity. Furthermore, the centralized server frequently needs to make changes and/or upgrade a configuration of the electronic device. As the high speed data connectivity to the electronic device is difficult, often such changes and/or upgrades fail or are time consuming. If the electronic device is disconnected then data connectivity is not possible. Additionally, in an event wherein the centralized server of the Internet of Things network fails, the entire network collapses due to its dependency on the centralized server. Furthermore, in such network architecture the centralized server needs to perform multiple functions, thus, the centralized server may not be efficient.

Therefore, in light of the foregoing discussion, there exists a need to overcome the aforementioned drawbacks associated with control of network including the Internet of Things devices.

### SUMMARY

The present disclosure seeks to provide a server arrangement for control of Internet of Things devices.

Furthermore, the present disclosure seeks to provide a gateway device for control of Internet of Things devices.

Moreover, the present disclosure seeks to provide a method for the control of Internet of Things devices.

The present disclosure also seeks to provide a method for control of Internet of Things devices, performed at a server arrangement.

The present disclosure also seeks to provide a method for control of Internet of Things devices, performed at a gateway device.

In one aspect, an embodiment of the present disclosure provides a server arrangement comprising:
a network interface for connection to a gateway device;
a data store; and
processing means, wherein the processing means are configured to:
   establish through the network interface, a network connection with the gateway device;
   transfer security credentials over the network connection to the gateway device associated with the server arrangement, to enable the gateway device to obtain control of one or more Internet of Things devices;
   establish an agency relationship with the gateway device or user of the gateway device to authorise the gateway device or user of the gateway device to perform control of Internet of Things devices on behalf of the server arrangement, creating a distributed management architecture;
   assign tasks to the gateway device to be performed on behalf of the server arrangement;
   receive from the gateway device, over a network connection, event data relating to Internet of Things devices controlled by the gateway device; and
   store the event data in the data store.

The present disclosure seeks to provide a solution to the existing problem of control of Internet of Things devices; moreover, the present disclosure seeks to provide control of the Internet of Things devices that is robust and that remains functional at a low bandwidth and power.

Optionally, the server arrangement is configured to authorise multiple gateway devices, each to control multiple Internet of Things devices.

Optionally, the server arrangement is configured to assign tasks in respect of a given Internet of Things devices to more than one gateway device.

More optionally, the data store is a global data store storing event data for all the gateway and Internet of Things devices of the distributed management architecture.

More optionally, the server arrangement includes a master clock and is configured to perform clock synchronisation, using the master clock, with the gateway device and directly with Internet of Things devices.

Yet more optionally, the event data are stored in the data store in an event sourcing format.

Yet more optionally, the security credentials include digital certificates.

Optionally, the security credentials are in the form of a signed concise binary object representation object.

The server arrangement may comprise an identity access management server configured to establish the authentication of a user of the gateway device and a secure device access server configured to establish an authorisation of the user of the gateway device to communicate with Internet of Things devices via the gateway device.

The authorisation of the user of the gateway device established by the secure device access server may provide a first level of authorisation allowing reboot of the Internet of Things devices.

The authorisation of the user of the gateway device established by the secure device access server may provide a second level of authorisation allowing a firmware update of the Internet of Things devices.

The server arrangement may be configured to replay the tasks at the server arrangement, compare the replayed tasks to the received event data and identify a malicious attack if the replayed tasks do not match the received event data.

Yet more optionally, the server arrangement is a central server.

In another aspect, an embodiment of the present disclosure provides a gateway device for control of Internet of Things devices, the gateway device comprising:
a network interface for connection to a server arrangement;
a local data store;
a device interface for connecting to one or more Internet of Things devices; and
processing means of the gateway device, wherein the processing means of the gateway device are configured to:
   establish through the network interface a network connection with the server arrangement;
   establish an agency relationship with the server arrangement to create a distributed management architecture, the agency relationship authorising the gateway device to perform control of Internet of Things devices on behalf of the server arrangement;
   receive security credentials over a network connection to the server arrangement;
   establish through the device interface a data connection to one or more Internet of Things devices;
   use the received security credentials to obtain control of the one or more Internet of Things devices;
   receive tasks assigned from the server arrangement, over a network connection, for the gateway device to perform on behalf of the server arrangement;
   perform assigned tasks on the one or more Internet of Things devices asynchronously;
   receive from the one or more Internet of Things devices, over a data connection, event data relating to the one or more Internet of Things devices;
   store the received event data in the local data store; and
   transfer to the server arrangement, over a network connection, the event data relating to the one or more Internet of Things devices from the local data store.

Optionally, the gateway device is configured periodically to synchronise its clock with a master clock provided by the server arrangement.

More optionally, the received event data are stored in the data store in an event sourcing format.

Yet more optionally, the security credentials include digital certificates.

Optionally, the security credentials are in the form of a signed concise binary object representation object. Yet more optionally, the server arrangement or the gateway is a central server.

In another aspect, an embodiment of the present disclosure provides a method for the control of Internet of Things devices, comprising:
establishing a data connection between a server arrangement and a gateway device;
transferring security credentials from the server arrangement over the data connection to the gateway device, to enable the gateway device to obtain control of one or more Internet of Things devices;
establishing an agency relationship between the server arrangement and the gateway device or user of the gateway device to authorise the gateway device or user of the gateway device to perform control of Internet of Things devices on behalf of the server arrangement, creating a distributed management architecture;
assigning tasks to the gateway device to be performed on behalf of the server arrangement;
establishing a local network connection between the gateway device and the Internet of Things device;
using the transferred security credentials to establish a secure relationship between the gateway device and Internet of Things devices; and
performing one or more of the assigned tasks on the Internet of Things device;
receiving at the gateway device, via a local network connection, event data from the Internet of Things device in respect of performed tasks;
transmitting from the gateway device to the server arrangement, over a data connection, event data relating to Internet of Things devices controlled by the gateway device; and
storing the transmitted event data in a data store.

In another aspect, an embodiment of the present disclosure provides a method for the control of Internet of Things devices, performed at a server arrangement, the method comprising:
establishing a data connection between the server arrangement and a gateway device;
transferring security credentials from the server arrangement to the gateway device over the data connection, to enable the gateway device to establish a secure relationship between the gateway and an Internet of Things device and to obtain control of the Internet of Things devices;
establishing an agency relationship between the server arrangement and the gateway device or user of the gateway device authorising the gateway device or user of the gateway device to perform control of Internet of Things devices on behalf of the server arrangement, creating a distributed management architecture;
assigning tasks to the gateway device to be performed on behalf of the server arrangement;
subsequently receiving from the gateway device event data relating to assigned tasks performed on or by the Internet of Things device; and
storing the received event data in a data store.

Optionally, the method further comprises replaying the tasks at the server arrangement, comparing the replayed tasks to the received event data and identifying a malicious attack if the replayed tasks do not match the received event data.

Optionally, in an event that a conflict is detected between event data reported by different gateway devices in respect of the same Internet of Things devices, the server arrangement uses synchronisation data received from the same Internet of Things devices to resolve the conflict.

More optionally, the synchronisation data is clock offset data representing an offset between a clock of the server arrangement and a clock of the same Internet of Things devices.

Yet more optionally, the synchronisation data is received by the server arrangement directly from the same Internet of Things devices.

In another aspect, an embodiment of the present disclosure provides a method for the control of Internet of Things devices, performed at a gateway device, the method comprising:
establishing a data connection between a server arrangement and the gateway device;
receiving security credentials from the server arrangement over the data connection;
establishing an agency relationship between the server arrangement and the gateway device or user of the gateway device authorising the gateway device or user of the gateway device to perform control of Internet of Things devices on behalf of the server arrangement, creating a distributed management architecture;
receiving an assignment of tasks to be performed on behalf of the server arrangement;
establishing a local network connection between the gateway device and an Internet of Things device;
using the received security credentials to establish a secure relationship between the gateway and the Internet of Things device;
performing assigned tasks on the Internet of Things device asynchronously;
receiving from the Internet of Things device, over a local network connection, event data relating to the Internet of Things device;
storing the received event data in a local data store; and
transmitting to the server arrangement, over a data connection, event data relating to the Internet of Things device.

Optionally, the local network connection between the gateway device and the Internet of Things devices is provided using PAN, LPWAN or other wireless area network technology.

Optionally, the event data are stored in an event sourcing format.

Optionally, the Internet of Things device stores the event data in an Internet of Things device data store, the event data relating, at least, to tasks performed at the Internet of Things device.

Optionally, the event data is signed by the Internet of Things device.

More optionally, the security credentials include digital certificates.

Optionally, the security credentials are in the form of a signed concise binary object representation object.

Yet more optionally, the server arrangement is a central server.

Yet more optionally, the data connection between the server arrangement and the gateway device is provided using Wi-Fi, UMTS or other digital cellular technology.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of an architecture for control of Internet of Things devices, in accordance with different embodiments of the present disclosure.

FIG. 2 is a block diagram of an architecture for control of Internet of Things devices, in accordance with different embodiments of the present disclosure.

FIG. 3 is an illustration of communications between a gateway device and an Internet of Things device according to embodiments of the disclosure.

FIG. 4 is a flow chart of a verification process at a server arrangement according to embodiments of the disclosure.

FIGS. 5 and 6 are schematic illustrations of example embodiments depicting implementations of the architecture of FIG. 1, in accordance with different embodiments of the present disclosure;

FIGS. 7A and 7B are an illustration of steps of a method for the control of Internet of Things devices, in accordance with an embodiment of the present disclosure;

FIG. 8 is an illustration of steps of a method for the control of Internet of Things devices, performed at a server arrangement, in accordance with an embodiment of the present disclosure; and

FIGS. 9A and 9B are an illustration of steps of a method for the control of Internet of Things devices, performed at a gateway device, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

In overview, embodiments of the present disclosure are concerned with control of Internet of Things devices in an efficient manner.

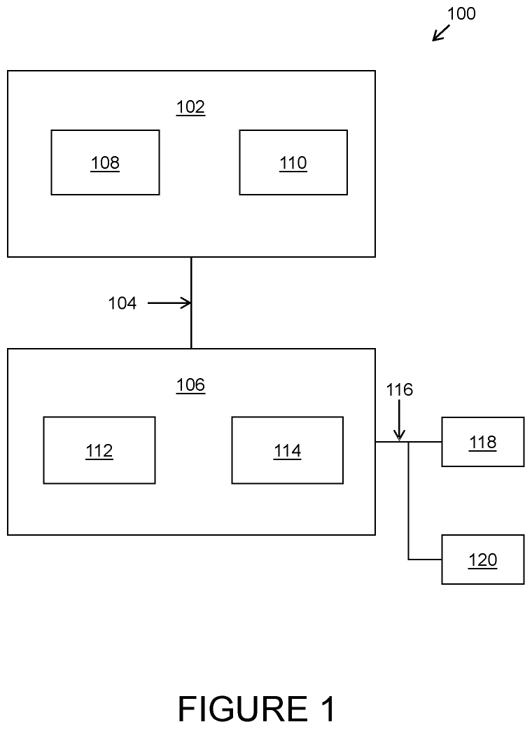

Referring to FIG. 1, there is shown a block diagram of an architecture 100 for control of Internet of Things devices, in accordance with different embodiments of the present disclosure. The architecture 100 includes a server arrangement 102. The server arrangement 102 for control of Internet of Things devices comprises a network interface 104 for connecting to a gateway device 106, a data store 108 and processing means 110. As shown the gateway device 106 includes a local data store 112, processing means 114 and device interface 116 for connection to two or more Internet of Things devices 118 and 120.

Throughout the present disclosure, the term ‘server arrangement’ relates to a structure and/or module that include programmable and/or non-programmable components configured to store, process and/or share information. Optionally, the server arrangement 102 includes any physical or virtual computational entities capable of enhancing information to perform various computational tasks. Furthermore, the server arrangement 102 could be hosted in a cloud computing environment.

Optionally, the server arrangement 102 could be implemented as a plurality of servers operating in a parallel or distributed architecture. In an example, the plurality of servers may form a decentralized computing environment, wherein the plurality of servers is connected to each other. Furthermore, the plurality of servers of the server arrangement 102 is operable to perform different tasks and/or provide services for controlling and control gateway devices. Optionally, gateway device 106 includes electronic devices (such as smartphones, tablet computer and so forth) that are capable of communicating with the server arrangement 102, (explained herein later in greater detail). In an example, one of the servers of the server arrangement 102 may be operable to store security information related to the gateway device 106 connected to the server arrangement 102. In another example, one of the servers of the server arrangement 102 may be operable to acquire data from the gateway device 106 and perform analysis of the acquired data. Optionally, functioning of a server of the plurality of servers is based on the type of the service rendered by the server. In an example, a server of the plurality of servers may provide a service of authenticating the gateway device 106 that requests connection with the server arrangement 102. In such instance, the server performing the authentication of the gateway device 106 may be activated when the gateway device 106 requests connection to the server arrangement 102. In another example, a server of the plurality of servers may provide a service of data collection from the gateway device 106 connected with the server arrangement 102. Furthermore, the server performing the data collection service form the gateway device 106 may be continuously functional. Optionally, the server arrangement 102 could be implemented as a computer program hosted in a single hardware component that provides various services to other devices. For example, the server arrangement 102 may be a centralized server that is operable to perform all the tasks related to the controlling and/or control of the gateway devices.

The server arrangement 102 comprises a network interface 104 for connecting to a gateway device 106. Throughout the present disclosure, the term ‘network interface’ relates to an arrangement of interconnected programmable and/or non-programmable components that are configured to facilitate data communication between one or more electronic devices (such as the server arrangement 102 and the gateway device 106), whether available or known at the time of filing or as later developed. The data connection between the server arrangement 102 and the gateway device 106 is provided using Wi-Fi, Ethernet, LPWAN, Satellite, UMTS, or other digital cellular technology. Furthermore, the network interface 104 may include, but is not limited to, a hybrid peer-to-peer network, local area networks (LANs), radio access networks (RANs), metropolitan area networks (MANS), wide area networks (WANs), Low powered wide area networks (LPWAN), all or a portion of a public network such as the global computer network known as the Internet, a private network, a cellular network and any other communication system or systems at one or more locations. Additionally, the network interface 104 includes wired or wireless communication that can be carried out via any number of known protocols, including, but not limited to, Internet Protocol (IP), Wireless Access Protocol (WAP), Frame Relay, or Asynchronous Transfer Mode (ATM). Moreover, any other suitable protocols using voice, video, data, or combinations thereof, can also be employed. Moreover, the network interface 104 may be implemented using various protocols such as, TCP/IP, IPX, Appletalk, IP-6, NetBIOS, OSI, any tunneling protocol (e.g. IPsec, SSH), or any number of existing or future protocols. Optionally, the network interface 104 is a high-speed data communication channel.

The server arrangement 102 comprises a data store 108. Throughout the present disclosure, the term “data store” relates to a volatile or persistent medium, such as an electrical circuit, magnetic disk, virtual memory, optical disk, solid-state storage in which digital information, data and/or software is stored. Optionally, the data store 108 is programmable hardware. Optionally, the data store 108 is a non-volatile memory device. Optionally, the non-volatile memory device is a non-volatile mass storage device such as physical storage media. Furthermore, in a scenario wherein computing system is distributed, the memory device may encompass processing and/or storage capability in a distributed manner. Optionally, the data store 108 includes a database arrangement for storing data. For example, the data stored in the database arrangement may include the data related to the gateway device (such as the gateway device 106) and/or one or more Internet of Things devices (such as more Internet of Things devices 118 and 120). Furthermore, the term ‘database arrangement’ as used herein relates to an organized body of digital information regardless of the manner in which the data or the organized body thereof is represented. Optionally, the database arrangement may be hardware, software, firmware and/or any combination thereof. For example, the organized body of digital information may be in a form of a table, a map, a grid, a packet, a datagram, a file, a document, a list or in any other form. The database arrangement includes any data storage software and systems, such as, for example, a relational database like IBM DB2, Oracle 9, PostgreSQL, SQLite, CouchDB, and MongoDB. Optionally, the database arrangement is a software program for creating and control one or more databases.

The server arrangement 102 comprises processing means 110. Throughout the present disclosure, the term ‘processing means’ as used herein, relates to programmable and/or non-programmable components configured to execute one or more software application for storing, processing and/or sharing data and/or a set of instructions. Optionally, the processing means 110 include one or more data processing facilities for storing, processing and/or sharing data and/or set of instructions. Furthermore, the processing means 110 include hardware, software, firmware or a combination of these, suitable for storing and processing various information and services accessed by the one or more devices (such as the gateway device 106). Optionally, the processing means 110 include functional components, for example, a processor, a memory, and so forth.

The processing means 110 are configured to establish through the network interface 104, a network connection with the gateway device 106. Throughout the present disclosure, the term “gateway device” relates to an electronic device that is capable of performing specific tasks associated with the architecture 100. Furthermore, the gateway device 106 is intended to be broadly interpreted to include any electronic device that may be used for data communication over a wireless communication network. Examples of the gateway device 106 include, but are not limited to, cellular phones, personal digital assistants (PDAs), handheld devices, wireless modems, laptop computers, personal computers, embedded computers, and so forth. Optionally, the gateway device 106 can be implemented as a dedicated electronic device that includes an application processor. Optionally, the gateway device 106 can be implemented an electronic device designed to perform a specific task. Optionally, the gateway device 106 is implemented as a mobile station, a mobile terminal, a subscriber station, a remote station, a user terminal, a terminal, a subscriber unit, an access terminal, and suchlike. Optionally, the gateway device 106 includes a casing, a memory, a processor (such as a baseband processor), a network interface card, a microphone, a speaker, a keypad, a display and so forth. Optionally, the gateway device 106 is to be construed broadly, so as to encompass a variety of different types of mobile stations, subscriber stations or, more generally, communication devices, including examples such as a combination of a data card inserted in a laptop. Such communication devices are also intended to encompass devices commonly referred to as “access terminals”.

Optionally, the network connection between the server arrangement 102 and the gateway device 106 can be established in various manners through the network interface 104. In an example, the network connection may be a two-way communication channel that is established directly between the server arrangement 102 and the gateway device 106. In another example, the server arrangement 102 may be hosted in the cloud computing architecture. In such instance, the gateway device 106 may be configured to initiate the communication with the server arrangement 102 via the network interface 104.

Optionally, the server arrangement 102 is operable to host a root of trust. Throughout the present disclosure, the term ‘root of trust’ relates to a set of instructions that is hosted and executed by a programmable component of the server arrangement 102. Optionally, the root of trust supports system verification, software and data integrity, and keeps keys and critical data confidential. Furthermore, the root of trust is associated with processes that are immutable and resistant to attack, and it works in conjunction with other system elements to ensure system security. Optionally, the root of trust is an entity hosted in the server arrangement 102 that can be trusted to behave in an expected manner. Optionally, the root of trust is hosted separately in a plurality of hardware. Therefore, in an event wherein the server arrangement 102 includes a plurality of servers, the root of trust is hosted separately in each of the servers. Furthermore, the server arrangement 102 implements the root of trust to communicate with other devices, such as the gateway device 106 (as explained herein later).

Optionally, the root of trust is an entity hosted in the server arrangement 102 that can be trusted to behave in an expected manner. Optionally, the root of trust can be implemented as a hardware root of trust. Optionally, a server among the plurality of servers of the server arrangement 102 can be implemented as common root of trust for the architecture 100. Optionally, the root of trust is operable to generate device digital certificates for the gateway devices 108 and the Internet of Things devices 118 and 120. Optionally, the device digital certificates are used to determine a chain of trust for communication amongst the gateway devices 108 and the Internet of Things devices 118 and 120. Optionally, the root of trust implemented as a server among the plurality of servers of the server arrangement 102. Furthermore, the root of trust is operable to sign the digital certificates used to authenticate the gateway device and the Internet of Things device 118 and 120. Optionally, the digital certificate includes root of trust certificate identification number, a signature generated using the root of trusts private key and the public key of the root of trust.

Optionally, each server of the plurality of servers of the server arrangement 102 can be configured to operate as individual root of trusts, and wherein the servers are connected to several gateway devices, each gateway device will receive digital certificates from each of the roots of trust for initiating a communication. Furthermore, in an event wherein a root of trust associated with a gateway device is compromised, this root of trust associated with the gateway device is nullified. Additionally, in an event wherein the gateway device requests re-initiation of communication with the server arrangement 102, a replacement trust certificate is provided to the gateway device from each of the roots of trust of the servers for initiating a communication.

The processing means 110 are configured to transfer security credentials over the network connection to the gateway device 106 associated with the server arrangement 102, to enable the gateway device 106 to obtain control of the Internet of Things devices 118 and 120. Throughout the present disclosure, the term ‘Internet of Things devices’ relates to electronic devices that are configured to transmit data related to a specific function performed by the device.

Optionally, the Internet of Things devices 118 and 120 are devices that are configured to include an addressable interface that can be used to transmit information to one or more other devices (such as the gateway device and/or the Internet of Things devices) over at least one wired and/or wireless connection. Optionally, the addressable interface includes one or more of the, but is not limited to, media access control (MAC) address, BT MAC, LoraWAN address, Internet Protocol (IP) address, Bluetooth identifier (ID), near-field communication (NFC) identifier (ID), and the likes. Optionally, the Internet of Things devices 118 and 120 are configured to establish communication with one or more other devices (such as the gateway devices) using various communication mechanisms, such as, NFC polling, BLE discovery, mDNS/Bonjour, QR codes, barcodes and the likes. Optionally, the Internet of Things devices 118 and 120 may include smart home controller, router, fire alarm, security camera, fitness tracker, speaker, television, gaming console, PC, laptop, tablet, thermostat, furnace, air conditioner, heat pump, hot water heater, light, alarm system, appliance (e.g., refrigerator, oven, stove, dishwasher, washing machine, dryer, microwave oven, etc.), sensor, lawn mower, vehicle, head-mounted display, clothing, and so forth. Optionally, the processing means 110 of the server arrangement 102 are configured to transfer the security credentials after the trust chain with the gateway device 106 has been established. Optionally, the architecture 100 includes asymmetric cryptographic system to provide secure communication between the server arrangement (such as the server arrangement 102), the gateway device (such as the gateway device 106) and the Internet of Things devices (such as the Internet of Things devices 118 and 120). Optionally, the asymmetric cryptographic system is operable to generate a pair of keys including a public key and a private key, for providing secure communication. Optionally, the public key of the pair of keys is used to encrypt a communication and the private key of the pair of keys is used to decrypt the communication. Optionally, the security credentials are generated using the asymmetric cryptographic system. Optionally, the security credentials provided to the gateway device 106 includes a public key of the server arrangement 102 and the digital certificate to provide proof of authentication of the server arrangement 102. It may be appreciated that in such instance the server arrangement 102 is implemented as a single server and is operating as the root of trust for the architecture 100. Optionally, the gateway device 106 is operable encrypt a commutation to be sent to the server arrangement 102 using the public key of the server arrangement 102. Furthermore, the gateway device 106 is operable is operable to decrypt a communication from the server arrangement 102 using a private key generated by the gateway device 106 generated locally in the gateway device 106. Optionally, in the event wherein the server arrangement 102 is connected to more than one gateway devices, the public key and the digital certificate is broadcasted to both the more than one gateway devices. Furthermore, the public key is used to verify that a gateway device providing a corresponding private key sent the message, and encryption, whereby only the holder of the corresponding private key can decrypt the message encrypted with the public key.

Optionally, the asymmetric cryptographic system includes a random number generator to generate the security credentials for the server arrangement 102, the gateway device 106 and the Internet of Things devices 118 and 120. Optionally, the server arrangement 102, the gateway device 106 and the Internet of Things devices 118 and 120 each includes random number generator arranged locally therein. Subsequently, the random number generators generate distinct pair of keys (including the public and private keys) for the server arrangement 102, the gateway device 106 and each of the Internet of Things devices 118 and 120. In such instance, the gateway device 106 may be operable to encrypt a communication (such as message containing data related to a specific Internet of Things device) with the public key of the security credentials. Furthermore, in such instance, the server arrangement 102 may be operable to decrypt the communication sent by the gateway device 106 with the distinct private key provided in the security credentials of the server arrangement 102.

Optionally, the random number generator is used as part of a key-agreement protocol for generating the security credentials. For example, in an event wherein the server arrangement 102 and the gateway device 106 want to communicate, the server arrangement 102 will combine its own private key with the public key of the gateway device 106. Similarly, the gateway device 106 will combine its private key with the public key of the server arrangement 102. In such instance, mutually identical keys are generated at the server arrangement 102 and at the gateway device 106. Furthermore, the mutually identical keys enable to encrypt and authenticate communications between the server arrangement 102 and the gateway device 106. Optionally, the key-agreement protocol is Diffie-Hellman protocol and/or Elliptic-curve Diffie-Hellman protocol. Optionally, the key-agreement protocol is Rivest-Shamir-Adleman (RSA). It may be appreciated that at least one of the aforesaid algorithm is used to generate the identical keys (symmetrical keys) used for the encryption and decryption of the communications between the server arrangement 102 and the gateway device 106.

Optionally, the server arrangement 102 may provide the security credentials to the gateway device 106, that the gateway device 106 uses to control one or more Internet of Things devices 118 and 120. Furthermore, the gateway device 106 is operable to control the information related to the Internet of Things devices 118 and 120 to be sent to the server arrangement 102. In such instance, the digital certificate of the security credentials of the gateway device 106 includes the public key of the gateway device 106, an identification number of the gateway device 106, the root of trust certificate identification number, and a description of rights being delegated to the gateway device 106 and a signature generated using the root of trusts private key. Furthermore, the gateway device 106 is operable to control the data provided to the Internet of Things devices 118 and 120. For example, the gateway device 106 is operable to determine when to provide the Internet of Things devices 118 and 120 with the data for performing a firmware update.

Optionally, the security credentials include digital certificates. Optionally, the digital certificates are electronic documents that are used to prove the ownership of a public key. For example, the security credentials enable the gateway device 106 to authenticate the gateway device 106 for securely communicating with the server arrangement 102. Additionally, the digital certificates included in the security credentials are used to delegate rights by the server arrangement 102 to the gateway device 106.

Optionally, the asymmetric cryptographic system is implemented as a signature system to generate the digital certificates to provide encrypted communication. For example, the gateway device 106 has to send data related to an Internet of Things device (such as one or more of the Internet of Things devices 118 and 120) to the server arrangement 102. In such an instance, the data sent by the gateway device 106 includes the digital certificate of the gateway device 106. Additionally, the server arrangement 102 may authenticate the digital certificate of the gateway device 106. Furthermore, the server arrangement 102 examines the digital certificate of the gateway device 106 to determine if the digital certificate of the gateway device 106 is signed by the private key of the root of trust (i.e. a private key of a server operating as a root of trust in the server arrangement 102) and compares the signature in the digital certificate with the public key of the root of trust.

Optionally, the asymmetric cryptographic system uses RSA algorithm for generating digital certificates. Furthermore, the RSA algorithm includes plurality of steps for generating digital certificates, such as key generation, key distribution, encryption and decryption. Optionally, the asymmetric cryptographic system uses Elliptic Curve Digital Signature Algorithm for generating digital certificates.

The processing means 110 are configured to establish an agency relationship with the gateway device 106, to create a distributed management architecture, to authorise the gateway device 106 to perform control of Internet of Things devices 118 and 120 on behalf of the server arrangement 102. Optionally, the agency relationship relates to ascertaining a trustworthiness of the gateway device 106 in order to authorise the gateway device 106 to perform control of the Internet of Things devices 118 and 120 on behalf of the server arrangement 102. Optionally, the digital certificates are generated by the root of trust. In an example, the root of trust R is an entity delivering certificates to the server arrangement 102, the gateway device 106 and/or the Internet of Things devices 118 and 120 in the network. In such instance, the root of trust R has a pair of public/private keys. Furthermore, the server arrangement 102, the root of trust R, the gateway device 106 and/or the Internet of Things devices 118 and 120 associated to the network has the public key of the root of trust R. In such instance, the server arrangement 102, the gateway device 106 and/or the Internet of Things devices 118 and 120 each include their individual public keys. In another example, the public key is uploaded to the server arrangement 102, the gateway device 106 and/or the Internet of Things devices 118 and 120 during the provisioning process in a secure environment that occurs during manufacturing of the devices. In such instance, the root of trust R can grant the gateway device 106 a digital certificate to carry out specific operations on the Internet of Things device 118. Thereafter, at the first step, the root of trust R verifies the security credentials of the gateway device 106.

Optionally, the gateway device 106, authorised to perform control of the Internet of Things devices 118 and 120, is configured to function as local server for the Internet of Things devices 118 and 120. In an example, the gateway device 106 is operable to maintain the necessary data communication with the Internet of Things devices 118 and 120, in order to sustain operation of the Internet of Things devices 118 and 120. In an example, the server arrangement 102 may authorise the gateway device 106 to replicate the functionality of the server arrangement 102. In one example, the authorised gateway device 106 may be operable to ascertain the root of trust for the Internet of Things devices 118 and 120. In such instance, the authorised gateway device 106 may be operable to generate and process the digital certificates of the Internet of Things devices 118 and 120.

Optionally, the server arrangement 102 is configured to authorise multiple gateway devices each to control multiple Internet of Things devices. Furthermore, server arrangement 102 ascertains the root of trust for each one of the gateway devices. Thereafter, the server arrangement 102 authorises the multiple gateway devices each to control multiple Internet of Things devices 118 and 120.

The processing means 110 are configured to assign tasks to the gateway device 106 to be performed on behalf of the server arrangement 102. Optionally, the server arrangement 102 is operable to provide the gateway device 106 with an authorisation to operate as the server arrangement 102. Optionally, the server arrangement 102 is operable to provide the gateway device 106 with necessary information and the authorisation to operate as a local server. For example, the gateway device 106 may be operable to perform tasks as the local server. In such instance, the gateway device 106 may be operable to set up the communication and/or operation standards with the Internet of Things devices 118 and 120. Moreover, the gateway device 106 may be operable to reconfigure the Internet of Things devices 118 and 120. In such instance, the gateway device 106 may be operable to remotely control the operation of the Internet of Things devices 118 and 120. Furthermore, the gateway device 106 may be operable to remotely update the Internet of Things devices 118 and 120, such as a firmware update.

Optionally, the server arrangement 102 is configured to assign tasks in respect of a given Internet of Things device to more than one gateway device. In an example, two gateway devices may be connected to the server arrangement 102, and an Internet of Things device (such as the Internet of Things device 118) is communicably connected with both the gateway devices. In such instance, the server arrangement 102 may be operable to assign different tasks to the two gateway devices to be performed with respect to the Internet of Things device 118. For example, the server arrangement 102 may be operable to assign a task of remotely controlling the Internet of Things device 118 to one gateway device and a task of acquiring the operational data of the Internet of Things device 118 to the other gateway device connected to the Internet of Things device 118.

The processing means 110 are configured to receive from the gateway device 106, over a network connection, event data relating to Internet of Things devices 118 and 120 controlled by the gateway device 106. The gateway device 106 is operable to store the event data related to the Internet of Things devices 118 and 120. Optionally, the event data of the Internet of Things devices 118 and 120 is the data that describes all actions performed by the Internet of Things devices 118 and 120. In an example, an event data related to the Internet of Things devices 118 may include the information related to provisioning of the device, when the device was added to the network, the activities performed by the device, hardware version associated with the device, firmware operating in device, version of the firmware and so forth. Optionally, the event data is stored in the database arrangement as objects. Optionally, the gateway device 106 is operable to employ event sourcing to store event data related to the Internet of Things devices 118 and 120 in the database arrangement. Optionally, each event is created with a timestamp, which allows all the events to be ordered chronologically. Therefore, in an event wherein a task is performed, a current state of each object can be determined by compiling all the events related to the given object starting with its creation. Therefore, the database arrangement is capable of showing the current states of objects.

The processing means 110 are configured to store the event data in the data store 108. The event data related to the Internet of Things devices 118 and 120 that is provided by the gateway device 106 is stored in the data store 108. Optionally, the event data in the data store 108 includes the event data related to the gateway device 106. Additionally, the event data relates to the gateway device 106 describes all the actions performed by the gateway device 106. Furthermore, the event data related to the Internet of Things devices 118 and 120 provided by the gateway device 106 and the event data related to the gateway device 106 are stored in the data store 108 in an event source format.

Optionally, the server arrangement 102 includes a master clock and is configured to perform clock synchronization, using the master clock, with the gateway device 106 and directly with the Internet of Things devices 118 and 120. Optionally, the server arrangement 102 synchronizes with the gateway device 106 in order to chronological update the event data in the data store 108. Optionally, the clock synchronization is operable to enable the gateway device 106 and Internet of Things devices 118 and 120 to operate independently. Optionally, the clock synchronization can be implemented using various protocols, such as Network Time Protocol (NTP). Optionally, the gateway device 106 is configured to periodically synchronize its clock with the master clock provided by the server arrangement 102. Optionally, the gateway device 106 is configured to synchronize its clock with the master clock provided by the server arrangement 102 after a specific time period. Optionally, in an event when a conflict is detected between event data reported by different gateway devices in respect of the same Internet of Things device, the server arrangement 102 uses synchronisation data received from the same Internet of Things device. Optionally, the synchronisation data is received by the server arrangement 102 directly from the same Internet of Things device 118. In an example, the server arrangement 102 may authorise more than one gateway devices to control a single Internet of Things device (such as the Internet of Things device 118). In such an instance, the event data reported by both the gateway devices with respect to the Internet of Things device 118 may be different. Furthermore, in such an instance, the server arrangement 102 may be operable to directly communicate with the Internet of Things devices 118 and acquire synchronisation data from the Internet of Things device 118. Furthermore, the server arrangement 102 may be operable to store the synchronisation data from the Internet of Things device 118 in an event sourcing format in the data store 108. Optionally, the synchronisation data is clock offset data representing an offset between a clock of the server arrangement and a clock of the same Internet of Things device.

The gateway device 106 comprises a network interface 104 for connection to a server arrangement 102, a local data store 112, a device interface 116 for connection to one or more Internet of Things devices 118 and 120, and processing means 114 of the gateway device 106. Optionally, the network interface 104 used by the gateway device 106 to connect with the server arrangement 102 is the same network interface that is used by the server arrangement 102 to connect with the gateway device 106, as mentioned hereinabove. Optionally, the local data store 112 is similar to the data store 108, such that the local data store 112 is a volatile or persistent medium in which digital information, data and/or software is stored. Furthermore, the local data store 112 is programmable hardware and a database arrangement for storing event data. Furthermore, the local data store 112 is operable to store event data related to the one or more Internet of Things devices 118 and 120 connected therein, in an event sourcing format. Additionally, the local data store 112 is the storage device of the gateway device 106. In an example, the gateway device 106 may be a smart phone and the local data store 112 may be an internal memory of the smart phone.

Optionally, the device interface 116 for connection to one or more Internet of Things devices 118 and 120 is a low bandwidth radio communication interface that is capable of transferring from a few 100 bps, to a few 10 kbps. Optionally, the device interface 116 is a long range low bandwidth radio communication interface. Furthermore, the device interface 116 enables low data rate wireless communications to be made over long distances. Examples of such long range low bandwidth radio communication interface may include, but are not limited to LoRa, SigFox or similar Low-Power Wide-Area Network (LPWAN), and combinations thereof. Optionally, device interface 116 is operable to ensure basic data transmission. Optionally, the network connection between the gateway device 106 and the Internet of Things device 118 and 120 is provided using Personal Area Network (PAN), Low-Power Wide-Area Network (LPWAN) or other wireless area network technology. Optionally, the device interface 116 can include Bluetooth®, Bluetooth Low Energy (BLE), Near-field communication (NFC) and the like. Optionally, the device interface 116 is capable of facilitating major operations such as firmware upgrade, complete device reconfiguration and so forth.

Optionally, the processing means 114 of the gateway device 106 are similar to processing means 110, such as the processing means 114 relate to programmable and/or non-programmable components configured to execute one or more software application for storing, processing and/or sharing data and/or a set of instructions. For example, the processing means 114 include one or more data processing facilities for storing, processing and/or sharing data and/or the set of instructions.

The processing means 114 of the gateway device 106 are configured to perform one or more actions that are similar to the plurality of actions performed by the processing means 110 of the server arrangement 102, such as the processing means 114 establish through the network interface, a network connection with the server arrangement. Furthermore, the processing means 114 establish an agency relationship with the server arrangement 102 to create a distributed management architecture, the agency relationship authorizing the gateway device 106 to perform control of Internet of Things devices on behalf of the server arrangement 102.

The processing means 114 of the gateway device 106 are configured to receive security credentials over a network connection from the server arrangement 102. Optionally, the server arrangement 102 is operable to provide the security credentials generated by using an algorithm that include the random number generator. Additionally, the server arrangement 102 is operable to authenticate the gateway device 106 by implementing root of trust. The processing means 114 of the gateway device 106 are configured to establish through the device interface 116, a data connection to one or more Internet of Things devices 118 and 120. Optionally, the gateway device 106 establishes connection with the one or more Internet of Things devices 118 and 120 in a manner that is similar to the manner that the server arrangement 102 uses to establish communication with the gateway device 106. For example, the gateway device 106 verifies the security credentials of the one or more Internet of Things devices 118 and 120. In another example, the gateway device 106 may be configured to use the digital certificate signed by the root of trust to authenticate the trustworthiness of the one or more Internet of Things devices 118 and 120. In such instance, the gateway device 106 may temporarily with the server arrangement 102 to authenticate the one or more Internet of Things devices 118 and 120. The processing means 114 of the gateway device 106 are configured to use the received security credentials to obtain control of the one or more Internet of Things devices. Optionally, the gateway device 106 uses the received security credentials to acquire authorization from the server arrangement 102 to operate as local server for the one or more Internet of Things devices 118 and 120. The processing means 114 of the gateway device 106 are configured to receive tasks assigned from the server arrangement 102, over a network connection, for the gateway device 106 to perform on behalf of the server arrangement 102. Optionally, the server arrangement 102 is operable to provide authorization and instructions to the gateway device 106, to perform actions on the one or more Internet of Things devices 118 and 120. In an example, the server arrangement 102 may be operable to authorize the gateway device 106 to operate as a server for the one or more Internet of Things devices 118 and 120. In an example, the server arrangement 102 may be operable to authorize the gateway device 106 to replicate functionalities of the server arrangement 102 for the one or more Internet of Things devices 118, in an event wherein the server arrangement 102 is non-functional. The processing means 114 of the gateway device 106 are configured to perform assigned tasks on the one or more Internet of Things devices 118 and 120 asynchronously. Optionally, the gateway device 106 is configured to operate independently. The performance of the assigned tasks on the one or more Internet of Things devices 118 and 120 may be carried out whilst the gateway device 106 is disconnected from the server arrangement 102.

Based on the outcome of previous tasks and contextual data, parameters of the assigned tasks may be modified within predetermined bounds. For example, the order of the commands in assigned tasks could be changed.

Furthermore, the gateway device 106 is operable to communicate with and control the one or more Internet of Things devices 118 and 120 independently. In an example, the gateway device 106 is operable to determine a time frame for performing a task on the one or more Internet of Things devices 118 and 120. In such instance, the server arrangement 102 may assign the gateway device 106 with the task. The processing means 114 of the gateway device 106 are configured to receive from the one or more Internet of Things devices 118 and 120, over a data connection, event data relating to the one or more Internet of Things devices. Optionally, the data related to the activities performed by the one or more Internet of Things devices 118 and 120 is sent to the gateway device 106, via the data connection of the device interface 116. In an example, the Internet of Things device 120 may be a fitness tracker used by a user. In an example, the fitness tracker may be operable to send the data describing the body temperature of the user as event data to the gateway device 106, such as a smart phone used by the user, via the data connection of the device interface 116, such as Bluetooth®. The processing means 114 of the gateway device 106 are configured to store the received event data in the local data store. In another example, the smart phone is operable to store the event data related to the body temperature of the user in an internal memory of the smart phone. Optionally, the received event data are stored in the data store in an event sourcing format. The processing means 114 of the gateway device 106 are configured to transfer to the server arrangement 102, over a network connection, the event data relating to the one or more Internet of Things devices 118 and 120 from the local data store. In an example, the event data related to a body temperature of the user that is stored in the local data store, such as an internal memory of the smart phone may be transferred to the server arrangement 102, over the network connection such as radio access networks (RANs).

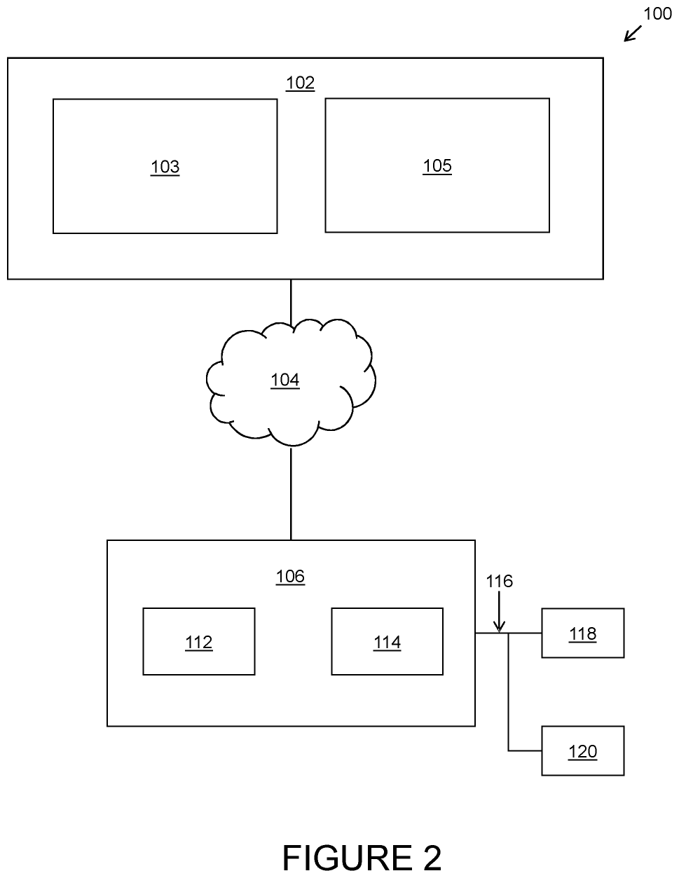

In an example, with reference to FIG. 2, alternative to or in addition to the gateway device 106 itself being authenticated and authorised to communicate with deployed devices, such as Internet of Things devices 118 and 120, a user of the gateway device 106 may be authenticated using an identity access management (IAM) process 103 and subsequently authorised to communicate with the Internet of Things devices 118 and 120 using a secure device access (SDA) process 105. The IAM process 103 and SDA process 105 are carried out on the server arrangement 102, which may comprise one or more servers which may be hosted in a cloud computing architecture. The user communicates with the Internet of Things devices 118 and 120 via the gateway device 106.

The gateway device 106 comprises a proxy application to enable the gateway device 106 to communicate with the server arrangement 102 and with the Internet of Things devices 118 and 120. The Internet of Things devices 118 and 120 comprise a client application to enable the Internet of Things devices 118 and 120 to communicate with the gateway device 106, for example, with the proxy application on the gateway device 106.

The gateway device 106 is configured to send login credentials for the user to the server arrangement 102. The server arrangement 102 is configured to receive login credentials for the user from the gateway device 106. For example, the login credentials may be provided in the form of a password, two-factor authentication, multi-factor authentication, an API key or other means of authentication.

Using an IAM process 103 on the server arrangement 102, the user may be authenticated as a user to which the server arrangement 102 may provide permissions to access and/or manipulate deployed devices, such as Internet of Things devices 118 and 120, via the gateway device 106.

When a user has been authenticated by the IAM process 103, a first token is sent from the server arrangement 102 to the gateway device 106 as proof of authentication of the user. The gateway device 106 may then receive the first token from the server arrangement 102.

In order for the user to access and/or manipulate Internet of Things devices 118 and 120, subsequent to receiving the first token from the server arrangement 102, the gateway device 106 is able to request, for example via the proxy application, authorisation to access and/or manipulate Internet of Things devices 118 and 120 from the server arrangement 102.

A request to the server arrangement 102 may comprise a scope of access and an Internet of Things device ID or set of IDs for a set of Internet of Things devices that the user wishes to have access to via the gateway device 106. The device ID or set of device IDs defines the audience, which is the list of Internet of Things devices that the user wishes to have access to. The audience can be based on or identified by arbitrary attributes, identified by their endpoint, or identified by device IDs, device type, device location, or any other attribute identifying a group of Internet of Things devices and to which the devices themselves are aware. For example, the request may comprise IDs for Internet of Things devices 118 and 120, and a scope to provide a firmware update, or to update an operating parameter for each of the Internet of Things devices 118 and 120.

The server arrangement 102 is configured to receive the request from the gateway device 106. Using an SDA process 105, which may be based on the concise binary object representation (CBOR) object signing and encryption (COSE) specification, the server arrangement 102 checks whether the user is authorised to access and/or manipulate the Internet of Things devices 118 and 120, and that the user is authorised to perform the requested scope of access for those Internet of Things devices 118 and 120. The SDA process 105 and the IAM process 103 may exchange authentication and authorisation data for the user in order to provide secure access to the Internet of Things devices 118 and 120. Information may be stored in the server arrangement 102 relating to which users may carry out which operations. For example a device owner may be able to reboot the Internet of Things device 118, 120 and update the firmware of the Internet of Things device 118, 120, whereas a technician may only be able to reboot the Internet of Things device 118, 120.

If the user is authorised to perform the requested scope of access for the identified Internet of Things devices 118 and 120, then a second token is sent from the server arrangement 102 to the gateway device 106 as proof of authorisation of the user. The second token can be in the form of a CBOR web token (CWT), and have an expiration date set by the SDA process 105 to a remote device owner or manager's preference. The second token may contain a copy of the public key of the gateway device 106, and be signed by the private key of the server arrangement 102.

Additionally an access control list (ACL) signed by the root of trust may be sent to the gateway device 106 from the server arrangement 102. The ACL defines the scope permissions to the Internet of Things devices 118 and 120. That is, the ACL defines the scope of allowable actions that the gateway device 106 is permitted to instruct the Internet of Things devices 118 and 120 to perform or execute.

Once the user is authorised to access and/or manipulate the Internet of Things devices 118 and 120, the user, via the gateway device 106, can connect to each of the Internet of Things devices 118 and 120 to perform suitable operations thereon. The gateway device 106 can be offline whilst accessing and/or manipulating the Internet of Things devices 118 and 120.

Once the user is authorised to access and/or manipulate the Internet of Things devices 118 and 120, the gateway device 106 requests a third token, in the form of a nonce (e.g., a unique pseudo-random number), from a particular Internet of Things device 118, 120, and receives, in response, a nonce, generated by the Internet of Things device 118, 120, which must be added to an operation bundle to be sent from the gateway device 106, to the Internet of Things device 118, 120, in order for the Internet of Things device 118, 120 to perform the actions defined by the scope of access.

In particular, the gateway device 106, via the proxy application, sends the operation bundle, comprising the nonce, the second token and the actions defined by the scope of access to the client application on the Internet of Things device 118, 120. The Internet of Things device 118, 120 receives the operation bundle form the gateway device 106. The second token may contain a public key of the user, so that the Internet of Things devices 118 and 120 can validate the authenticity of the operation bundle. The nonce may prevent or mitigate a replay attack on the Internet of Things device 118, 120, since it allows the Internet of Things device 118, 120 to verify that the nonce matches what is expected to verify that it received a fresh operation bundle comprising actions to be performed, and not an operation bundle that was created some time ago.

The Internet of Things devices 118 and 120 will only accept the second token if that second token is signed using a private key associated with the root of trust, the private key having a matching public key which is embedded in the Internet of Things devices 118 and 120 during initial setup of those Internet of Things devices 118 and 120. The private key that the second token may be signed by may be termed a trust anchor.

By using the IAM process 103 and SDA process 105, different users may be given different levels of access to the Internet of Things devices 118 and 120. A user may obtain the same level of access using different gateway devices 106 in order to connect to the Internet of Things devices 118 and 120, since the authorisations are user specific and not specific to the gateway device 106.

The Internet of Things devices 118 and 120 do not need to be connected to the server arrangement 102 in order for the gateway device 106 to communicate with the SDA process 105 for obtaining the second token. The gateway device 106 does not need to be connected to the server arrangement 102 when sending operation bundles.

Whilst the server arrangement 102 and the Internet of Things devices 118 and 120 are trusted entities, the gateway device 106 is not a trusted entity. The gateway device 106 is delegated responsibilities for instructing the Internet of Things devices 118 and 120 from the server arrangement 102. The ACL which defines the scope of allowable actions that the gateway device 106 is permitted to instruct the Internet of Things devices 118 and 120 to perform may therefore provide a security risk if the gateway device 106 is compromised. In particular, the gateway device 106 may need to conditionally execute instructions or select parameters based on previous responses from the Internet of Things devices 118 and 120, and therefore the gateway device 106 requires a broader scope of authorisation from the server arrangement 102 than the precise instructions that are actually executed on the Internet of Things devices 118 and 120.

If the gateway device 106 is compromised then it can be maliciously manipulated to change the order or sequence of the instructions provided to the Internet of Things devices 118 and 120. The Internet of Things devices 118 and 120 may still accept and carry out the instructions provided by the gateway device 106 as the instructions are still within the scope of the ACL, despite the instructions not being commensurate with the intended instructions from the server arrangement 102.

In order to mitigate for the potential compromise of the gateway device 106, the Internet of Things device 118, 120 retains an ordered log of the instructions that it was requested to perform by the gateway device 106. The ordered log may comprise event data relating to the Internet of Things device 118, 120, controlled by the gateway device 106. The Internet of Things device 118, 120 further signs the log. Therefore, the event data may be signed by the Internet of Things device 118, 120. The Internet of Things device 118, 120 creates a hash value, such as a rolling hash value, generated based on each instruction as it is received and executed by the Internet of Things device 118, 120.

The log is then passed via the gateway device 106 to the server arrangement 102, where the server arrangement 102 can perform a check on the log to ensure that the instructions performed by the Internet of Things device 118, 120 match the instructions that were intended to be performed by the Internet of Things device 118, 120.

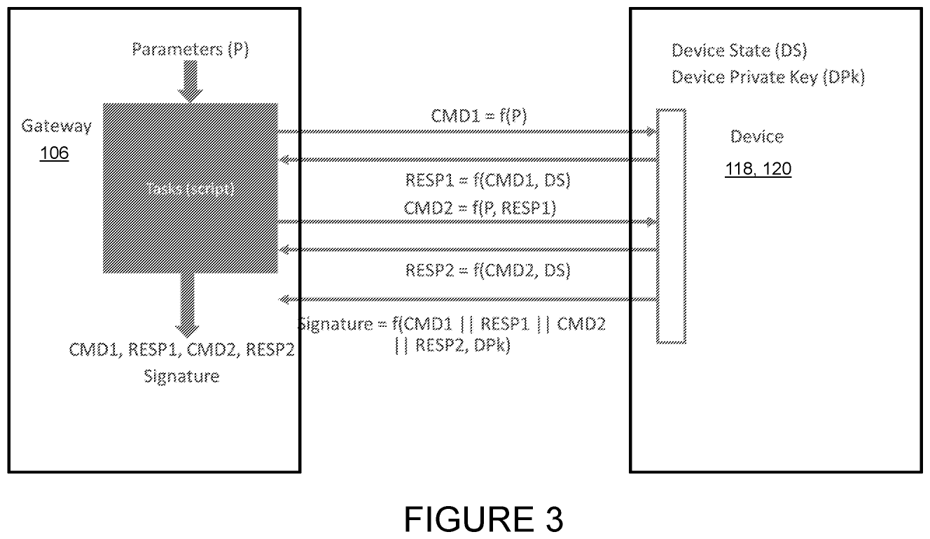

FIG. 3 illustrates the communications between the gateway device 106 and the Internet of Things device 118, 120, in an example embodiment. Initially the gateway device 106 receives parameters P from the server arrangement 102 and transmits a first command CMD1, which is a function of the received parameters P, to the Internet of Things device 118, 120.

The Internet of Things device 118, 120 provides a response RESP1 to the gateway device 106, the response RESP1 being a function of the command CMD1 performed and a device state DS of the Internet of Things device 118, 120.

The gateway device 106 then transmits a second command CMD2, which is a function of the received parameters P and the response RESP1, to the Internet of Things device 118, 120.

The Internet of Things device 118, 120 provides a second response RESP2 to the gateway device 106, the second response RESP2 being a function of the second command CMD2 performed and a device state DS of the Internet of Things device 118, 120.

The Internet of Things device 118, 120 further provides a signature to the gateway device 106, the signature being a function of the first command CMD1, the first response RESP1, the second command CMD2, the second response RESP2, and the private key DPk of the Internet of Things device 118, 120, to form a log.

The gateway device 106 transmits the log and the commands CMD1, CMD2 and responses RESP1, RESP2 to the server arrangement 102. The inclusion of the Internet of Things private key DPk in the signature ensures that the information transmitted to the server arrangement 102 can be trusted.

Since the Internet of Things device 118, 120 is trusted, the instructions sent from the gateway device 106 can be verified using the information received at the server arrangement 102.

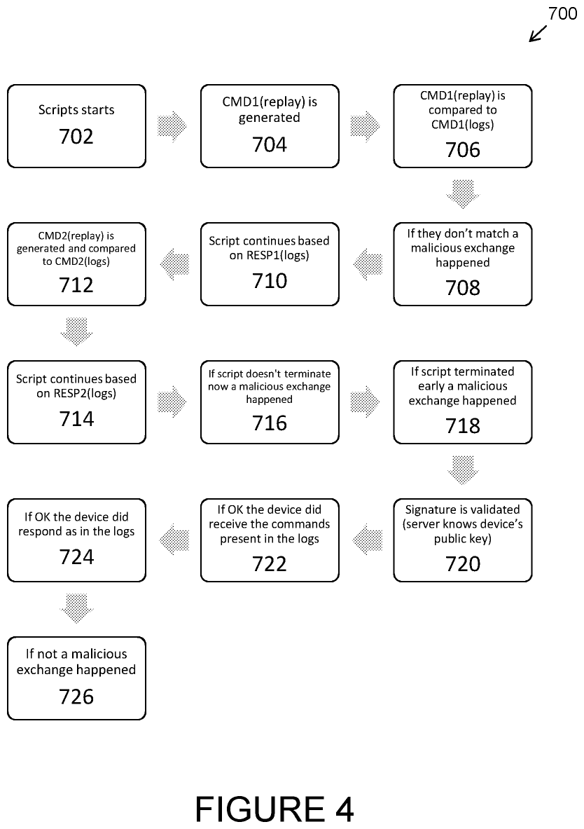

FIG. 4 then illustrates a process 700 at the server arrangement 102 for detecting a malicious attack on the gateway device 106. This process effectively replays the steps or blocks carried out by the gateway device 106 using the initial parameters P, the responses RESP1, RESP2 from the Internet of Things device 118, 120, and contextual parameters recorded in the log, such as time of execution, or any manual steps performed by the gateway device user.

When replaying the steps or blocks carried out by the gateway device 106, the server arrangement 102 checks that the exact same commands are generated for execution and that there are no additional commands or missing commands.

At block 702 the script on the server arrangement 102 starts.

At block 704 a replay of CMD1 is generated and at block 706 the replay of CMD1 is compared to CMD1 from the log. At block 708 a malicious exchange is considered to have happened if the replay of CMD1 does not match CMD1 from the log. In such an event the Internet of Things device 118, 120 may be re-instructed with the correct commands or the Internet of Things device 118, 120 status can be rolled back.

At block 710 the script continues based on RESP1 from the log. At block 712 a replay of CMD2 is generated and compared to CMD2 from the log. At block 714 the script continues based on RESP2 from the log. At block 716 it is determined that if the script doesn't terminate at this point a malicious exchange happened, as the replay does not match the log, and the Internet of Things device 118, 120 may then be re-instructed with the correct commands or the Internet of Things device 118, 120 status can be rolled back. At block 718 it is determined that if the script terminated early then a malicious exchange happened, as the replay does not match the log, and the Internet of Things device 118, 120 may then be re-instructed with the correct commands or the Internet of Things device 118, 120 status can be rolled back.

At block 720 the signature is validated, the server knowing the public key of the Internet of Things device 118,120. At block 722 it is determined that if the signature is valid then the Internet of Things device 118, 120 did receive the commands present in the logs, and at block 724 it is determined that if the signature is valid then the Internet of Things device 118, 120 did respond as in the logs. At block 726 it is determined that if the signature is not valid then a malicious exchange happened, and the Internet of Things device 118, 120 may then be re-instructed with the correct commands or the Internet of Things device 118, 120 status can be rolled back.

Whilst the embodiments herein described comprise two commands CMD1, CMD2 and two respective responses RESP1, RESP2 in the communications between the gateway device 102 and the Internet of Things device 124, 126, 128, any number of commands and respective responses may be performed, including more than two commands and more than two respective responses.

In some arrangements the server arrangement 102 may comprise a plurality of servers, the IAM process 103 being carried out on a first server, such as an IAM server, and the SDA process 105 being carried out on a second server, such as an SDA server. In alternative arrangements the server arrangement may comprise a single server comprising the functionality of the IAM process 103 and the SDA process 105.

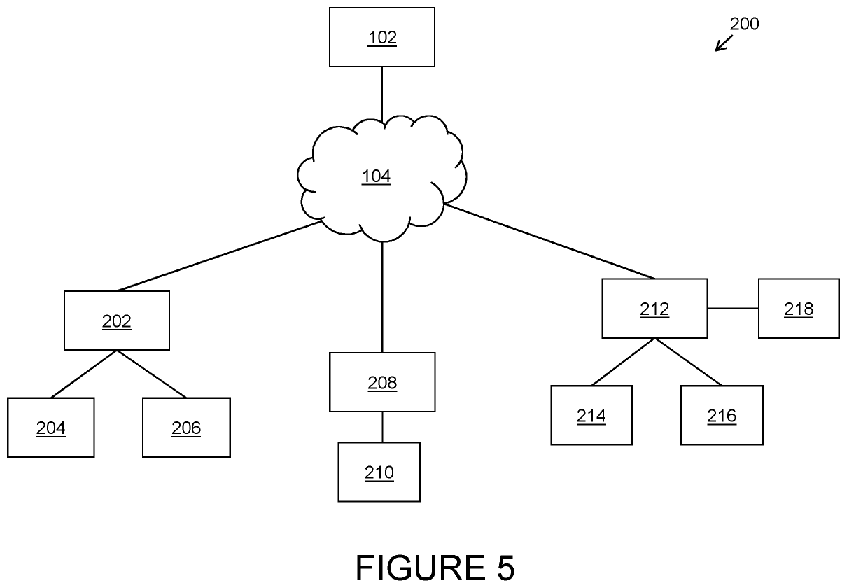

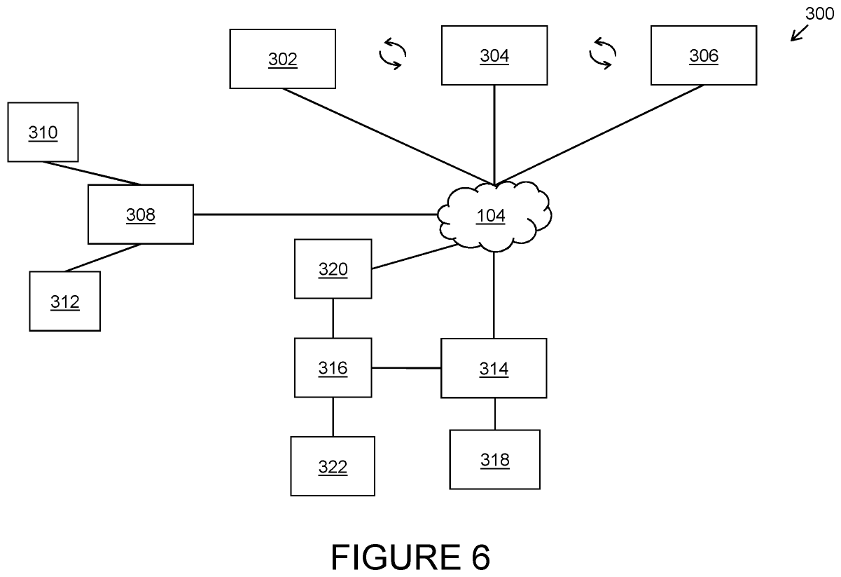

Referring to FIGS. 5 and 6, there are shown schematic illustrations of example embodiments depicting implementations of the architecture 100 of FIG. 1 and FIG. 2, in accordance with different embodiments of the present disclosure. Specifically, FIG. 5 illustrates an arrangement 200 of the architecture 100 of FIG. 1 and FIG. 2. As shown, the arrangement 200 includes the server arrangement 102, the network interface 104, plurality of gateway devices 202, 208, 212, and plurality of Internet of Things devices 204, 206, 210, 214, 216 and 218. Furthermore, the Internet of Things devices 204 and 206 are coupled to the gateway devices 202, the Internet of Things device 210 is coupled to the gateway device 208, and the Internet of Things devices 214, 216 and 218 are coupled to the gateway devices 212. Optionally, the arrangement 200 is a distributed arrangement, wherein the each one of one or more gateway devices 202, 208, 212, is connected to one or more Internet of Things devices 204, 206, 210, 214, 216 and 218. Optionally, the server arrangement 102 is operable to authorise the gateway devices 202, or user thereof, to control the Internet of Things devices 204 and 206. Additionally, the server arrangement 102 is operable to authorise the gateway devices 208, or user thereof, to control the Internet of Things device 210. Furthermore, the server arrangement 102 is operable to authorise the gateway devices 212, or user thereof, to control the Internet of Things devices 214, 216 and 218.

FIG. 6 illustrates another arrangement 300 of the architecture 100 of FIG. 1 and FIG. 2. As shown, the arrangement 300 includes a plurality of servers 302, 304, 306, the network interface 104, plurality of gateway devices 308 and 314, and plurality of Internet of Things devices 310, 312, 316, 318, 320 and 322. Optionally, the servers 302, 304, 306 are operable to perform various activities. Additionally, the servers 302, 304, 306 may operate synonymously as a single server arrangement (such as the server arrangement 102 of FIG. 1 and FIG. 2). Additionally, the servers 302, 304, 306 may be operating in parallel and arranged in a decentralized architecture. In one embodiment an IAM process 103 is carried out on one of the servers 302, 304, 306, whilst an SDA process 105 is carried out on another one of the servers 302, 304, 306. Optionally, the server 302 is operable to authorise the gateway devices 308 and 314 to control the Internet of Things devices 310, 312, 316, 318, 320 and 322 respectively. Optionally, the server 304 is operable to acquire and store the event data from the gateway devices 308 and 314. Optionally, the server 304 is operable to analyse the event data stored in the server 304 to determine various trends in the data. Optionally, the server 302 is operable to authorise the gateway devices 314 to operate as a local server. Furthermore, the gateway devices 314 may be operable to authorise an Internet of Things devices 316 to communicate with the Internet of Things devices 320 and 322 to acquire the event data related to the actions of the Internet of Things devices 320 and 322. Optionally the Internet of Things device 320 may be directly connected to the server 304. In such instance the Internet of Things device 320 may be operable to directly provide the event data to the server 304.

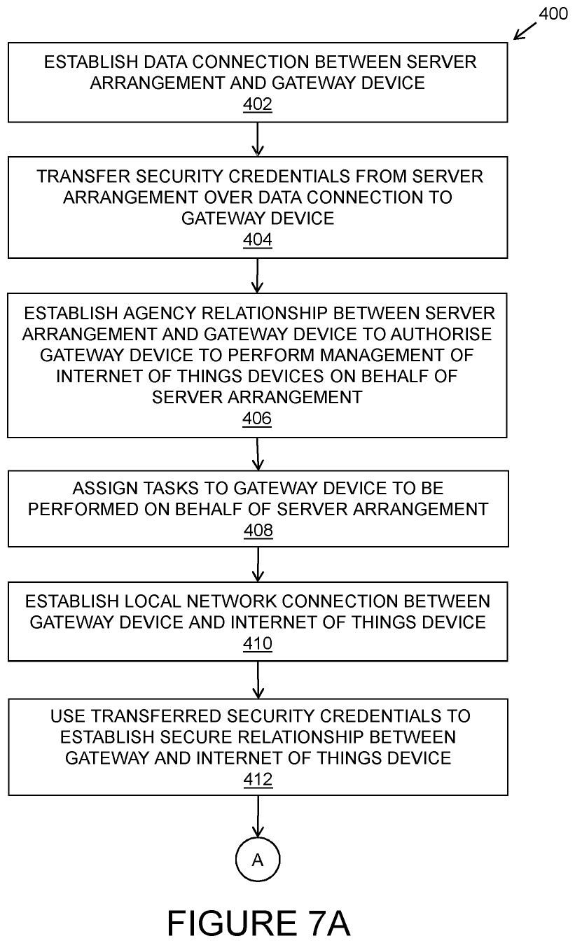

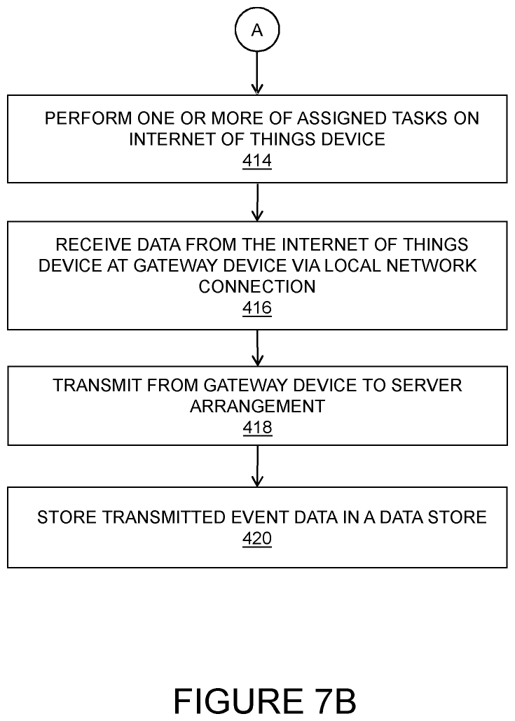

Referring to FIGS. 7A-7B, there are shown steps of a method 400 for the control of Internet of Things devices, in accordance with an embodiment of the present disclosure. At step 402 a data connection between a server arrangement and a gateway device is established. At step 404, the security credentials from the server arrangement is transferred over the data connection to the gateway device, to enable the gateway device to obtain control of one or more Internet of Things devices. At step 406, an agency relationship between the server arrangement and the gateway device is established to authorize the gateway device to perform control of Internet of Things devices on behalf of the server arrangement, creating a distributed management architecture. At step 408, tasks to the gateway device to be performed on behalf of the server arrangement is assigned. At step 410, a local network connection between the gateway device and the Internet of Things device is established. At step 412, the transferred security credentials are used to establish a secure relationship between the gateway and Internet of Things device. At step 414, one or more of the assigned tasks on the Internet of Things device is performed. At step 416, event data from the Internet of Things device in respect of performed tasks is received at the gateway device. At step 418, event data relating to Internet of Things devices controlled by the gateway device is transmitted from the gateway device to the server arrangement, over a data connection. At step 420, the transmitted event data is stored in a data store.

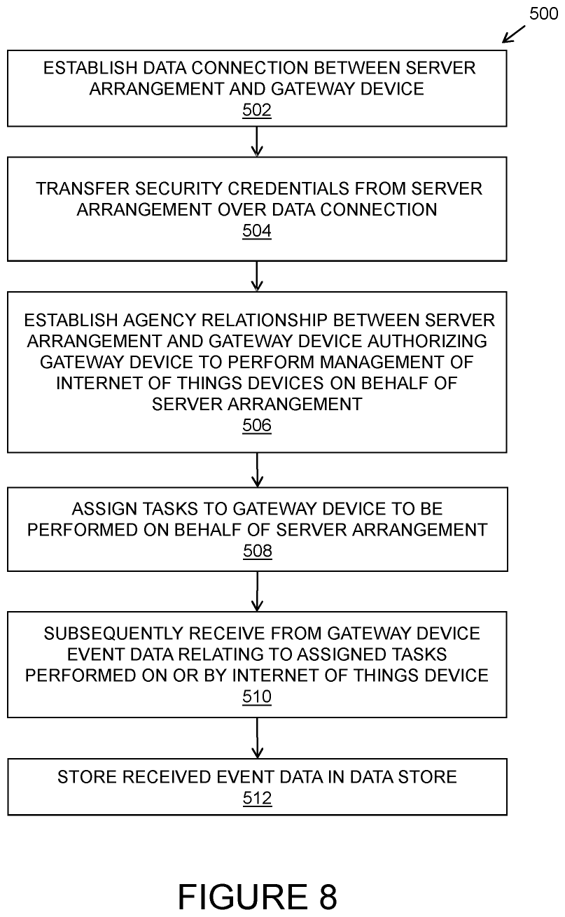

Referring to FIG. 8, there are shown steps of a method 500 for the control of Internet of Things devices, performed at a server arrangement, in accordance with an embodiment of the present disclosure. At step 502, a data connection between the server arrangement and a gateway device is established. At step 504 security credentials from the server arrangement to the gateway device are transferred over the data connection, to enable the gateway device to establish a secure relationship between the gateway and an Internet of Things device and to obtain control of the Internet of Things device. At step 506 an agency relationship between the server arrangement and the gateway device is established for authorizing the gateway device to perform control of Internet of Things devices on behalf of the server arrangement, creating a distributed management architecture. At step 508 tasks to the gateway device are assigned to be performed on behalf of the server arrangement. At step 510 event data is subsequently received from the gateway device relating to assigned tasks performed on or by the Internet of Things device. At step 512 the received event data is stored in a data store.

The steps 502 to 512 are only illustrative and other alternatives can also be provided where one or more steps are added, one or more steps are removed, or one or more steps are provided in a different sequence without departing from the scope of the claims herein. For example, the event when a conflict is detected between event data reported by different gateway devices in respect of the same Internet of Things device, the server arrangement uses synchronization data received from the same Internet of Things device. In another example, the synchronization data is clock offset data representing an offset between a clock of the server arrangement and a clock of the same Internet of Things device. In yet another example, the synchronization data is received by the server arrangement directly from the same Internet of Things device.

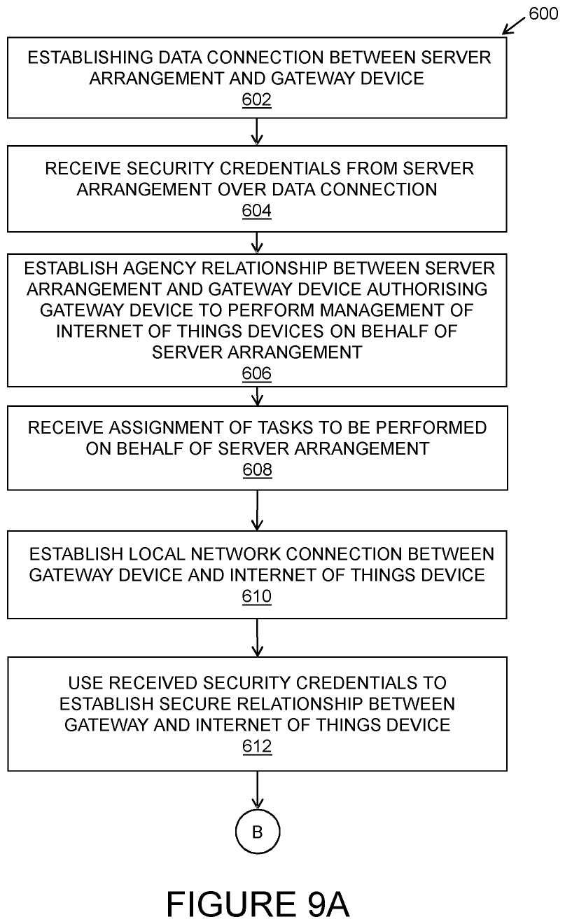

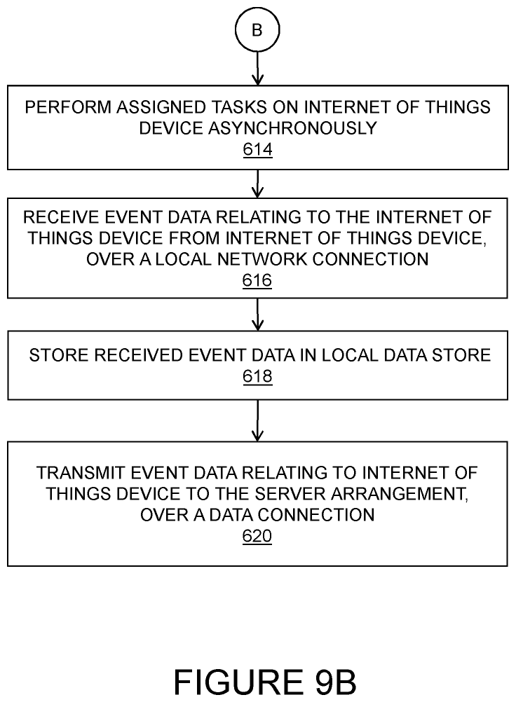

Referring to FIGS. 9A-9B, there are shown steps of a method 600 for the control of Internet of Things devices, performed at a gateway device, in accordance with an embodiment of the present disclosure. At step 602, a data connection between a server arrangement and the gateway device is established. At step 604, security credentials from the server arrangement over the data connection is received. At step 606, an agency relationship is established between the server arrangement and the gateway device authorizing the gateway device to perform control of Internet of Things devices on behalf of the server arrangement, creating a distributed management architecture. At step 608, an assignment of tasks to be performed on behalf of the server arrangement is received. At step 610, a local network connection is established between the gateway device and an Internet of Things device. At step 612, the received security credentials is used to establish a secure relationship between the gateway and the Internet of Things device. At step 614, assigned tasks on the Internet of Things device asynchronously performed. At step 616, event data relating to the Internet of Things device is received from the Internet of Things device, over a local network connection. At step 618, the received event data is stored in a local data store. At step 620, event data relating to the Internet of Things device is transmitted to the server arrangement, over a data connection.

The steps 602 to 620 are only illustrative and other alternatives can also be provided where one or more steps are added, one or more steps are removed, or one or more steps are provided in a different sequence without departing from the scope of the claims herein. For example, the local network connection between the gateway and the Internet of Things device is provided using PAN, LPWAN or other wireless area network technology. In another example, the event data are is stored in an event sourcing format. In another example, the event data are is stored in an event sourcing format wherein the security credentials include digital certificates. In another example, the server is a central server. In yet another example, the data connection between the server arrangement and the gateway device is provided using Wi-Fi, Ethernet, LPWAN, Satellite, UMTS, or other digital cellular technology.

The server arrangement for control of Internet of Things devices of the present disclosure provides an arrangement with improved efficiency for control of Internet of Things devices. The server arrangement includes the gateway device and the Internet of Things devices connected in a decentralized structure. Beneficially, the decentralized structure remains operational in the event wherein an element such as the server arrangement of the decentralized structure is not functional for a period of time. Furthermore, the server arrangement is capable of authorizing one or more gateway devices to perform actions on behalf of the server arrangement. Beneficially, such arrangement allows for the load sharing and/or balancing. Additionally, such arrangement allows for the one or more gateway devices to locally perform maintenance of the one or more Internet of Things devices, wherein the one or more Internet of Things devices are capable of communicating in low bandwidth commutation channel. Furthermore, the server arrangement implements event sourcing. Beneficially, such arrangement allows for the gateway device and the Internet of Things devices to operate independently. Furthermore, the server arrangement implements root of trust that enables the structure to be protected from potential cyber-attacks such as hacking.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A server arrangement comprising:
a network interface for connection to a gateway device;
a data store; and
processing means, wherein the processing means are configured to:
establish through the network interface a network connection to the gateway device;
transfer security credentials over the network connection to the gateway device associated with the server arrangement, to enable the gateway device to obtain control of one or more Internet of Things devices;
establish an agency relationship with the gateway device or user of the gateway device to authorise the gateway device or user of the gateway device to perform control of Internet of Things devices on behalf of the server arrangement, creating a distributed management architecture;
assign tasks to the gateway device to be performed on behalf of the server arrangement;
receive from the gateway device, over a network connection, event data relating to Internet of Things devices controlled by the gateway device; and
store the event data in the data store.

2. A server arrangement as claimed in claim 1, wherein the server arrangement is configured to authorise multiple gateway devices each to control multiple Internet of Things devices.

3. A server arrangement as claimed in claim 2, wherein the server arrangement is configured to assign tasks in respect of a given Internet of Things device to more than one gateway device.

4. A server arrangement as claimed in claim 2, wherein the data store is a global data store storing event data for all the gateway and Internet of Things devices of the distributed management architecture.

5. A server arrangement as claimed in claim 1, wherein the server arrangement includes a master clock and is configured to perform clock synchronisation, using the master clock, with the gateway device and directly with Internet of Things devices.

6. A server arrangement as claimed in claim 1, wherein the event data are stored in the data store in an event sourcing format.

7. A server arrangement as claimed in claim 1, wherein the security credentials include digital certificates or a signed concise binary object representation object.

8. A server arrangement as claimed in claim 1, comprising an identity access management server configured to establish the authentication of a user of the gateway device and a secure device access server configured to establish an authorisation of the user of the gateway device to communicate with Internet of Things devices via the gateway device.

9. A server arrangement as claimed in claim 8, wherein the authorisation of the user of the gateway device established by the secure device access server provides a first level of authorisation allowing reboot of the Internet of Things devices.

10. A server arrangement as claimed in claim 9, wherein the authorisation of the user of the gateway device established by the secure device access server provides a second level of authorisation allowing a firmware update of the Internet of Things devices.

11. A server arrangement as claimed in claim 1 wherein the server arrangement is configured to replay the tasks at the server arrangement, compare the replayed tasks to the received event data and identify a malicious attack if the replayed tasks do not match the received event data.

12. A gateway device for control of Internet of Things devices, the gateway device comprising:
a network interface for connection to a server arrangement;
a local data store;
a device interface for connection to one or more Internet of Things devices; and
processing means of the gateway device, wherein the processing means of the gateway device are configured to:
establish through the network interface a network connection with the server arrangement;
establish an agency relationship with the server arrangement to create a distributed management architecture, the agency relationship authorising the gateway device to perform control of Internet of Things devices on behalf of the server arrangement;
receive security credentials over a network connection from the server arrangement,
establish through the device interface a data connection to one or more Internet of Things devices;
use the received security credentials to obtain control of the one or more Internet of Things devices;
receive tasks assigned from the server arrangement, over a network connection, for the gateway device to perform on behalf of the server arrangement;
perform assigned tasks on the one or more Internet of Things devices asynchronously;
receive from the one or more Internet of Things devices, over a data connection, event data relating to the one or more Internet of Things devices;
store the received event data in the local data store; and
transfer to the server arrangement, over a network connection, the event data relating to the one or more Internet of Things devices from the local data store.

13. A gateway device as claimed in claim 12, wherein the gateway device is configured periodically to synchronise its clock with a master clock provided by the server arrangement.

14. A gateway device as claimed in claim 12, wherein the received event data are stored in the data store in an event sourcing format.

15. A gateway device as claimed in claim 12, wherein the security credentials include digital certificates or are in the form of a signed concise binary object representation object.

16. A server arrangement as claimed in claim 1, wherein the server arrangement is a central server.

17. A method for the control of Internet of Things devices, comprising:
establishing a data connection between a server arrangement and a gateway device;
transferring security credentials from the server arrangement over the data connection to the gateway device, to enable the gateway device to obtain control of one or more Internet of Things devices;
establishing an agency relationship between the server arrangement and the gateway device or user of the gateway device to authorise the gateway device or user of the gateway device to perform control of Internet of Things devices on behalf of the server arrangement, creating a distributed management architecture;
assigning tasks to the gateway device to be performed on behalf of the server arrangement;
establishing a local network connection between the gateway device and the Internet of Things device;
using the transferred security credentials to establish a secure relationship between the gateway and Internet of Things device; and
performing one or more of the assigned tasks on the Internet of Things device;
receiving at the gateway device, via a local network connection, event data from the Internet of Things device in respect of performed tasks;
transmitting from the gateway device to the server arrangement, over a data connection, event data relating to Internet of Things devices controlled by the gateway device; and
storing the transmitted event data in a data store.

18. A method for the control of Internet of Things devices, performed at a server arrangement, the method comprising:
establishing a data connection between the server arrangement and a gateway device;
transferring security credentials from the server arrangement to the gateway device over the data connection, to enable the gateway device to establish a secure relationship between the gateway and an Internet of Things device and to obtain control of the Internet of Things devices;
establishing an agency relationship between the server arrangement and the gateway device or user of the gateway device authorising the gateway device or user of the gateway device to perform control of Internet of Things devices on behalf of the server arrangement, creating a distributed management architecture;
assigning tasks to the gateway device to be performed on behalf of the server arrangement;
subsequently receiving from the gateway device event data relating to assigned tasks performed on or by the Internet of Things device; and
storing the received event data in a data store.

19. A method as claimed in claim 18, further comprising replaying the tasks at the server, comparing the replayed tasks to the received event data and identifying a malicious attack if the replayed tasks do not match the received event data.

20. A method as claimed in claim 17, wherein in the event that a conflict is detected between event data reported by different gateway devices in respect of the same Internet of Things device, the server arrangement uses synchronisation data received from the same Internet of Things device.

21. A method as claimed in claim 20, wherein the synchronisation data is clock offset data representing an offset between a clock of the server arrangement and a clock of the same Internet of Things device.

22. A method as claimed in claim 20, wherein the synchronisation data is received by the server arrangement directly from the same Internet of Things devices.

23. A method for the control of Internet of Things devices, performed at a gateway device, the method comprising:
establishing a data connection between a server arrangement and the gateway device;
receiving security credentials from the server arrangement over the data connection;
establishing an agency relationship between the server arrangement and the gateway device or user of the gateway device authorising the gateway device or user of the gateway device to perform control of Internet of Things devices on behalf of the server arrangement, creating a distributed management architecture;
receiving an assignment of tasks to be performed on behalf of the server arrangement;
establishing a local network connection between the gateway device and an Internet of Things device;
using the received security credentials to establish a secure relationship between the gateway and the Internet of Things device;
performing assigned tasks on the Internet of Things device asynchronously;
receiving from the Internet of Things device, over a local network connection, event data relating to the Internet of Things device;
storing the received event data in a local data store; and
transmitting to the server arrangement, over a data connection, event data relating to the Internet of Things device.

24. A method as claimed in claim 17, wherein the local network connection between the gateway and the Internet of Things device is provided using PAN, LPWAN or other wireless area network technology.

25. A method as claimed in claim 17, wherein the event data is stored in an event sourcing format.

26. A method as claimed in claim 17, wherein the Internet of Things device stores the event data in an Internet of Things device data store, the event data relating, at least, to tasks performed at the Internet of Things device.

27. A method as claimed in claim 26, wherein the event data is signed by the Internet of Things device.

28. A method as claimed in claim 17, wherein the security credentials include digital certificates or are in the form of a signed concise binary object representation object.

29. A method as claimed in claim 17, wherein the server is a central server.

30. A method as claimed in claim 17, wherein the data connection between the server arrangement and the gateway device is provided using Wi-Fi, Ethernet, LPWAN, Satellite UMTS, or other digital cellular technology.
